(19) United States
(12) Patent Application Publication
(10) Pub. No.: US 2003/0188039 A1
(43) Pub. Date: Oct. 2, 2003

(54) Method and apparatus for web service aggregation

(76) Inventors: James C. Liu, Sunnyvale, CA (US); Prashant Srinivasan, Santa Clara, CA (US)

Correspondence Address: ROSENTHAL & OSHA L.L.P. / SUN, 1221 MCKINNEY, SUITE 2800, HOUSTON, TX, 77010, US

(21) Appl. No.: 10/255,859

(22) Filed: Sep. 26, 2002

Related U.S. Application Data
(60) Provisional application No. 60/367,678, filed on Mar. 26, 2002.

(51) Int. Cl. G06F 9/44

(52) U.S. Cl. 709/315

(57) ABSTRACT

A method for defining an aggregate web service involves selecting a plurality of web services, extracting a definition language description from each of the plurality of web services, encapsulating the definition language description with a plurality of tags to produce a plurality of encapsulated definition language descriptions, and aggregating the plurality of encapsulated definition language descriptions to produce an aggregation taxonomy defining the aggregate web service.

### CROSS-REFERENCE TO RELATED APPLICATIONS

This application claims benefit of U.S. Provisional Application Serial No. 60/367,678 filed on Mar. 26, 2002, entitled “Method and Apparatus for Web Service Aggregation,” in the names of James Liu and Prashant Srinivasan.

### BACKGROUND OF INVENTION

A software service is a group of interconnected reusable software components that accept and return digital responses, e.g., a C function, a Java™ object, or a Structural Query Language (SQL) stored procedure. Software services typically reside in a computer system and maintain a particular platform and language. A computer application would be considered a well-orchestrated set of software services.

Web services are reusable software components that are accessible over a wide area network (WAN). Web services can be considered general-purpose architecture for distributed systems, which are location, platform, and language independent.

FIG. 1 shows a web service network diagram. A web service network (8) includes a client (10), a web server (14), and a web service registry (12) connected over a WAN (16), such as the Internet. The client (10) may access a web service or set of web services through a web browser. The web browser is an application used to locate and display graphical and textual information by acting as an interface for information on the WAN (16). The web browser is a client application that uses protocols to make requests of the web server (14) on behalf of the client (10) over the WAN (16). Web browsers typically use caching, i.e., temporarily storing information, and employ features that allow the client (10) to force particular actions, e.g., find functions, create favorite lists, etc.

Web services may also be accessed by the client (10) using protocol messages. One such protocol message is a Simple Object Access Protocol (SOAP) message. SOAP is a standard for network communication between software services. SOAP messages are represented using Extensible Markup Language (XML), which allows data to be represented in a simple, portable way. XML documents are self-describing and are easily manipulated and transformed. SOAP messages may be sent over any transport layer of a network, e.g., Hypertext Transfer Protocol (HTTP), Simple Mail Transport Protocol (SMTP), Java Messaging Service™ (JMS), etc. In general, a software service or a component of a software service is published as a web service, or made “web service enabled,” using a SOAP container. The SOAP container, which encapsulates the software service component, accepts incoming requests and dispatches requests to published components, i.e., existing web services, translating between the SOAP container and the web service's native language. SOAP containers are available in many programming languages, e.g., C++, Java™, Perl, etc.

Referring to FIG. 1, the client (10) uses a web browser or protocol messages, e.g., SOAP messages, to access the web server (14) or the web service registry (12), where descriptions of the web service are stored. One such description is a Web Services Description Language (WSDL) description. The WSDL provides an overview of the web service, including the functions of a web service, where the web service is located, and how to invoke the web service. The WSDL description may be stored with the web service on the web server (14) or registered in the web service registry (12). One such web service registry is a Universal Description Discovery and Integration (UDDI) repository. UDDI is a standard that allows information about businesses and services to be published and queried. UDDI provides a way for the WSDL to be stored and accessed using the web browser or SOAP messages.

The architecture by which web services operate is similar to the architecture used by traditional websites. Generally, websites may be considered all computer files accessed by the general public using a domain name, including all executable files, text files, HTML files, Common Gateway Interface (CGI) scripts, images, and graphics, which may be viewed, linked together, or downloaded as a single interactive unit. Websites like web services are often accessed through a proxy server. The proxy server sits between the client and the WAN, typically handling such functions as security, administrative controls, and caching. The proxy server receives requests from the client, which may be a webpage or a web service request. Once the request passes filtering requirements, the webpage or web service result is returned to the client if cached. Alternatively, the proxy server acts on the behalf of the client and sends the request to the server (or web service registry) where the webpage or web service resides on the WAN. When the webpage or web service is returned, the proxy server relates the webpage or web service to the original request and sends the webpage or the result of the web service to the client. From the client's perspective, the proxy server is invisible, however the proxy server's IP address is configured within the client's protocol program, e.g., a web browser or a web registry. The proxy server may also handle Servlets, Enterprise JavaBeans™ (EJBs), and Java Server Pages™ (JSPs), which are small browser-based programs that run on the proxy server. The Servlets and EJBs typically focus on computing business logic, where JSP focus on the presentation layer of webpages.

### SUMMARY OF INVENTION

In general, in one aspect, the invention relates to a method for defining an aggregate web service. The method comprises selecting a plurality of web services, extracting a definition language description from each of the plurality of web services, encapsulating the definition language description with a plurality of tags to produce a plurality of encapsulated definition language descriptions, and aggregating the plurality of encapsulated definition language descriptions to produce an aggregation taxonomy defining the aggregate web service.

In general, in one aspect, the invention relates to a method for defining an aggregate web service. The method comprises selecting a plurality of web services, extracting a definition language description from each of the plurality of web services, encapsulating the definition language description with a plurality of tags to produce a plurality of encapsulated definition language descriptions, aggregating the plurality of encapsulated definition language descriptions to produce an aggregation taxonomy defining the aggregate web service, introspecting the aggregate web service, deploying the aggregate web service to a web server container, performing a sequence of transactions defined by the aggregate web service and returning a result to a web services client, and registering the aggregate web service into a web service registry.

In general, in one aspect, the invention relates to a web services aggregation system. The system comprises a web service browser generating an aggregation taxonomy defining an aggregate web service, an aggregator using the aggregation taxonomy to deploy the aggregated web service, and a web service client sending a request to the aggregator to run the aggregated web service.

In general, in one aspect, the invention relates to a web services aggregation system. The system comprises a web service browser generating an aggregation taxonomy defining an aggregate web service, an aggregator using the aggregation taxonomy to deploy the aggregated web service, a web service client sending a request to the aggregator to run the aggregated web service, a web services registry with an address of the aggregate web service to direct the request from the web services client to the aggregator, an encapsulator located on the web services browser encapsulating a definition language description of each of a plurality of web services with a plurality of tags used in generating the aggregation taxonomy, and a menu feature of the web services browser comprising an introspect function, an invoke function, and a deploy function.

In general, in one aspect, the invention relates to a computer system for defining an aggregate web service. The system comprises a processor, a memory, an input means, and software instructions. Software instructions stored in the memory for enabling the computer system under control of the processor, perform selecting a plurality of web services, extracting a definition language description from each of the plurality of web services, encapsulating the definition language description with a plurality of tags to produce a plurality of encapsulated definition language descriptions, and aggregating the plurality of encapsulated definition language descriptions to produce an aggregation taxonomy defining the aggregate web service.

In general, in one aspect, the invention relates to an apparatus to define an aggregate web service. The system comprises means for selecting a plurality of web services, means for extracting a definition language description from each of the plurality of web services, means for encapsulating the definition language description with a plurality of tags to produce a plurality of encapsulated definition language descriptions, and means for aggregating the plurality of encapsulated definition language descriptions to produce an aggregation taxonomy defining the aggregate web service.

Other aspects and advantages of the invention will be apparent from the following description and the appended claims.

### BRIEF DESCRIPTION OF DRAWINGS

FIG. 1 shows a typical web services network system.

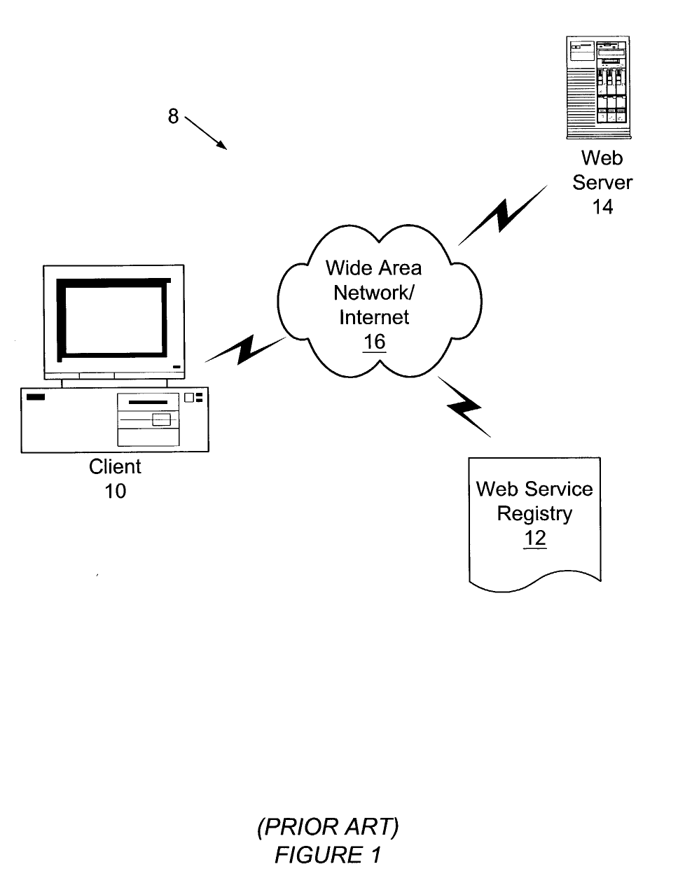

FIG. 2 shows a flow diagram of a web aggregation system in accordance one or more embodiments of the present invention.

FIG. 3 shows a flow diagram of a web services client requesting an aggregate web service in accordance with one or more embodiments of the present invention.

FIG. 4 shows a flow chart of the process of defining and accessing an aggregate web service in accordance with one or more embodiments of the present invention.

### DETAILED DESCRIPTION

Exemplary embodiments of the invention will be described with reference to the accompanying drawings. Like items in the drawings are shown with the same reference numbers.

In the following detailed description of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

The present invention relates to a method and apparatus for aggregating web services. The present invention allows a web application developer to use a standard method of web service lookup to locate and select web services, aggregate the web services, and, possibly, present the web services as an aggregate web service in itself.

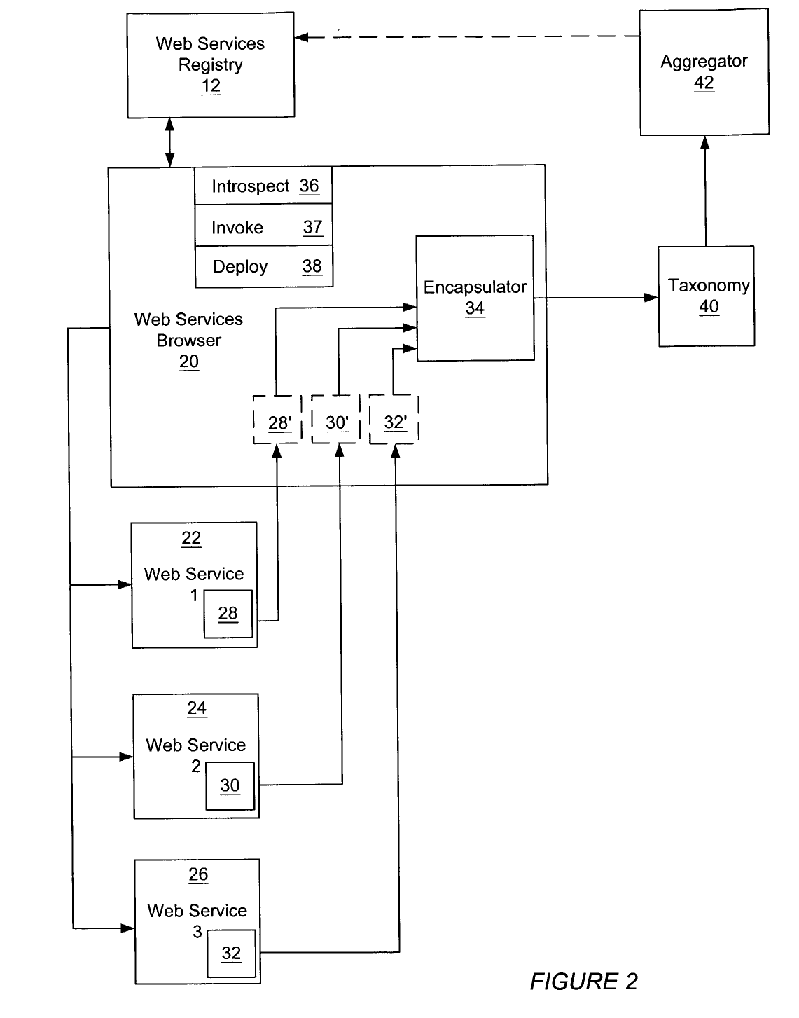

To accomplish the web service aggregation, several components are necessary. As shown in FIG. 2, a first component is a web service browser (20) that can locate and select web services (22, 24, 26) and then integrate the web services (22, 24, 26). The web service browser (20) also generates the second component, an aggregation taxonomy (40), defining the aggregate web service using an encapsulator (34). The aggregation taxonomy (40) is an XML description that defines the sequence and accessibility of the web services (22, 24, 26). The aggregation taxonomy (40) also defines the inputs and outputs from one web service to another and the specific web address where these web services are located. The third component is an aggregator (42), which is able to read and understand the aggregation taxonomy (40) and provides the runtime engine to deploy the defined aggregate web service.

The web service browser (20) is a tool used by a user, such as a developer, to locate and select web services (22, 24, 26), integrate the web services (22, 24, 26), and then uses an encapsulator (34) to generate the aggregation taxonomy (40). In one or more embodiments of the invention, the web service browser (20) provides a menu feature with menu options such as introspecting the web service more deeply (36), invoking a particular web service (37), deploying this web service as part of an aggregate web service (38), etc.

The user may use standard protocols, e.g., SOAP, to locate web services (22, 24, 26) at a web service registry (12), e.g., UDDI repository. The web services browser (20) presents a raw web service in an active and integrated user interface rather than transcribing accessor methods via a transferring of HTML text from a typical web page. As a result, a user can select a web service from the web service browser (20). The web services browser (20) then extracts the definition language description (28, 30, 32), e.g., a WSDL description, associated with each of the selected web services (22, 24, 26), and delivers a copy of the definition language description (28′, 30′, 32′) to the encapsulator (34) to create the aggregation taxonomy (40). Within the encapsulator (34), the definition language description (28′, 30′, 32′) is encapsulated with custom tags to define a set of web services while connecting the encapsulated set of web services. In one or more embodiments of the invention, the custom tags are XML tags.

In one or more embodiments of the invention, the encapsulator (34) includes extensible stylesheet language (XSL) templates that define how to transform the definition language descriptions (28′, 30′, 32′) into the aggregation taxonomy (40). The XSL templates and definition language descriptions (28′, 30′, 32′) are processed using an extensible stylesheet language transformation (XSLT) processor.

The web services browser (20) reinforces the familiar notion of having users (i.e., developers) clicking on a web service to force some action. In one embodiment, the web services browser (20) includes features such as web services caching such that developers are not required to go back continuously to the web services registry (12) to find common web services. The cache used by the web services browser (12) can be a shareable cache which also acts as a web service to allow a team of developers to locate and select known web services lists locally (saving more effort contacting outside web service registries). A web services browser (20) may also integrate a lightweight version of the web services aggregator and act as a web server and deployment platform for testing, peer-to-peer deployment, and a registry of web services.

The aggregation taxonomy (40) provides a platform-neutral way to describe the methods and properties of web services (22, 24, 26). Specifically, in an embodiment of the present invention, web services (22, 24, 26) described by definition language descriptions (28, 30, 32), e.g., WSDL leverage XML encapsulation to provide an encapsulated definition language description. This platform-neutral behavior of XML is used to define custom tags to define a set of web services while connecting the encapsulated set of web services, i.e., the aggregate web service. One skilled in the art can appreciate that the actual resulting vocabulary of the aggregation taxonomy (40) may be varied. In one embodiment, the aggregation taxonomy (40) may be defined in a cross-platform Java programming language that defines an XML schema and a set of custom tags that encapsulate the notion of a single function web service, as well as nesting of web services within web services. The structure of XML allows the set of tags to be re-exported in part or in whole to other web services that understand the particular XML schema.

In one or more embodiments of the invention, source code may be developed to generate an aggregation taxonomy (40) with schema-compliant aggregation statements in XML that alleviates a developer from having to manually enter the information. The result is an increase in schema compliance and conformance to the web service aggregation process.

At this point, an aggregate web service has been defined. Now, this definition needs to be deployed to a web server container and a host needs to be located for the web service. Returning to FIG. 2 and prior to deploying the aggregated web service, the web service aggregator (42) extracts the necessary information from the aggregation taxonomy (40) to generate a definition language description of the aggregate web service e.g., a WSDL description. The definition language description of the aggregate web service may be generated in any language as required by the web service registry, e.g., WSDL, Web Service Introspection Language (WSIL), etc. In one or more embodiments of the invention, the web service aggregator (42) includes XSL templates defining how to transform the aggregation taxonomy (40) into a definition language description of the aggregate web service. The XSL templates and the aggregation taxonomy (40) are processed using an XSLT processor. Additionally, the web service aggregator (42) includes an execution engine on which a request for the defined aggregate web service is run. Each individual piece in the aggregate transaction is executed and sequenced to provide a final result for the aggregate web service. In one embodiment, the web services aggregator (42) may be implemented on a Java™ Servlet container, such as an Apache Tomcat container. When the container is requested to fetch a server/local URL, the request is silently forwarded to another server and returns the result from the other server back to the requesting client.

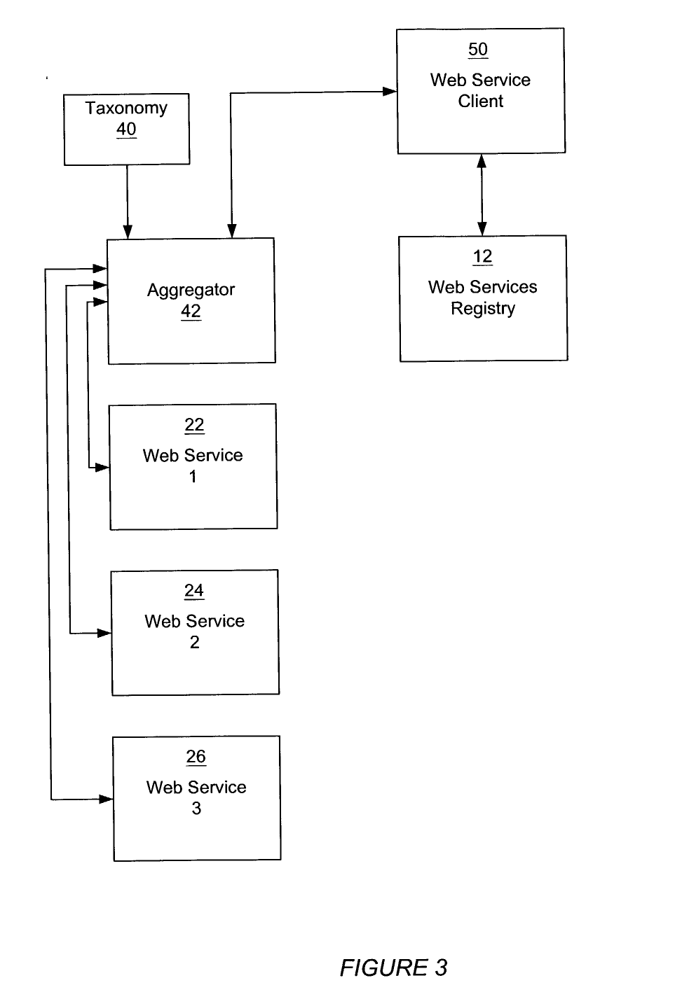

FIG. 3 shows a flow diagram of a web service client requesting an aggregate web service in accordance with one or more embodiments of the present invention. A web service client (50) prepares to send a request for a defined aggregate web service to the aggregator (42). Prior to sending the request, the client (50) seeks a definition language description of the aggregate web service from the web services registry (12). The definition language description defines the inputs and outputs from one web service to another and the specific web address where these web services (22, 24, 26) are located. Using this definition language description, the web service client (50) is able to locate the aggregator (42). The aggregator (42) extracts the necessary information from the aggregation taxonomy (40) to generate the definition of the aggregate web service. The web service aggregator (42) includes an execution engine on which the request from the web service client (50) for the defined aggregate web service is run. Each individual piece in the aggregate transaction, i.e., the business logic of the aggregate web services (22, 24, 26), is executed on the execution engine and sequenced to provide the final result for the aggregate web service. The final result is then returned to the web service client (50).

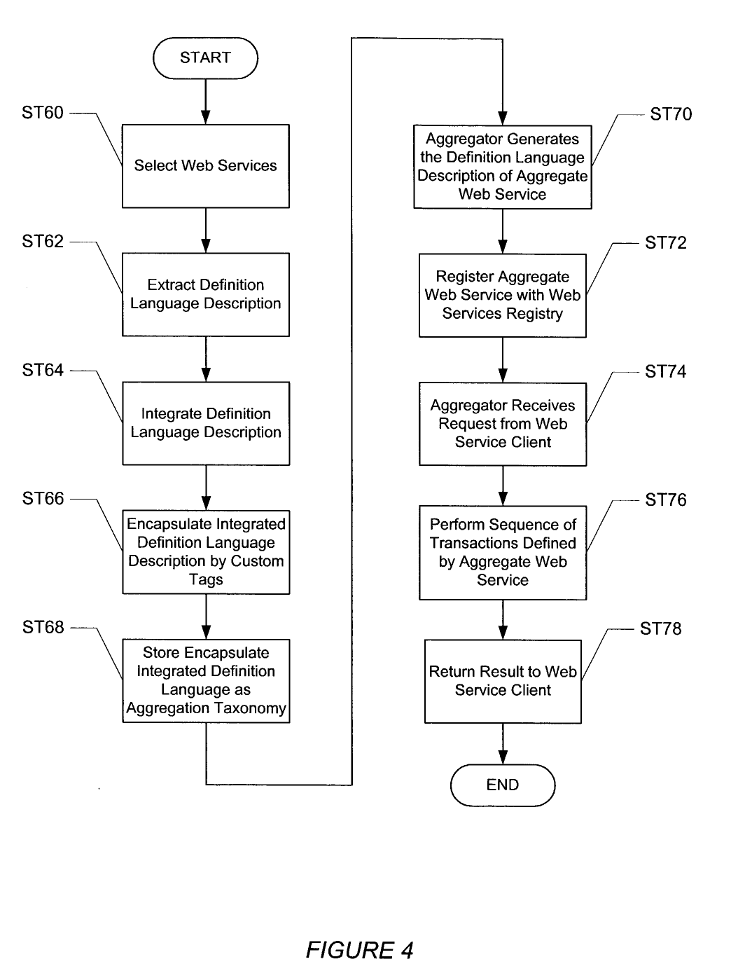

FIG. 4 shows a process of aggregating web services in accordance with one or more embodiments of the present invention. A developer selects at least two web services via a web services browser to create an aggregate web service (Step 60). The definition language description of the selected web services is then extracted (Step 62). The extracted definition language descriptions are then integrated (Step 64), and the integrated definition language description is encapsulated by custom tags (Step 66) and are stored as an aggregation taxonomy (Step 68). The aggregator then extracts the necessary information from the aggregation taxonomy to generate the definition language definition of the aggregate web service (Step 70). The aggregate web service may then be registered with the web services registry (Step 72), so that a web service client can request the aggregate web service. The aggregator, upon receiving the request from the web service client (Step 74) performs the sequence of transactions defined by the aggregate web service (Step 76), and then returns a result to the web service client (Step 78). The aggregated web service may also be aggregated with other web services.

A Tide Table web service for use by fisherman or sailors is an example of a web services that can use web service aggregation. The tide table web service, like a financial transaction, can include a number of web services. One web service is solar-lunar celestial motion data to predict position of the Sun and moon relative to the Earth. Another web service provides the locale and geographical datum for a local body of water (connected to the ocean). Another service computes the tide level given the data of the first and second web services. Aggregating these three web services by a developer seeking to create a Tide Table lookup service would require a tremendous effort using standard coding techniques. In one embodiment of the present invention, the developer is able to quickly aggregate all three web services, and export the aggregate web service as an end-user web service. The end-user web service may then be consumed by yet another web service.

Advantages of the present invention may include one or more of the following in one or more embodiments. The integration of web service definitions and addition of custom tags allows flexible arrangement whereby portions of web services may be aggregated and aggregated web services may be further aggregated. The use of a standard schema for the web service definition allows an increase in schema compliance and conformance to the web service aggregation process. The use of web services caching reduces the number of roundtrips necessary to the web services registry. The aggregation of web services allows more and more web site content to be borrowed by others who leverage web services. Those skilled in the art appreciate that the present invention may include other advantages and features.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1] A method for defining an aggregate web service, comprising:
selecting a plurality of web services;
extracting a definition language description from each of the plurality of web services;
encapsulating the definition language description with a plurality of tags to produce a plurality of encapsulated definition language descriptions; and
aggregating the plurality of encapsulated definition language descriptions to produce an aggregation taxonomy defining the aggregate web service.

2] The method of claim 1, wherein the definition language description is web services description language description.

3] The method of claim 1, wherein the plurality of tags are defined by extensible markup language.

4] The method of claim 1, wherein the aggregate web service communicates via a simple object access protocol message.

5] The method of claim 1, the aggregate web service comprising in turn a plurality of aggregate web services.

6] The method of claim 1, further comprising:
introspecting the aggregate web service.

7] The method of claim 1, further comprising:
deploying the aggregate web service to a web server container.

8] The method of claim 1, further comprising:
performing a sequence of transactions defined by the aggregate web service and returning a result to a web services client.

9] The method of claim 1, further comprising:
registering the aggregate web service into a web service registry.

10] The method of claim 9, wherein the web service registry is universal description discovery and integration-compliant.

11] A method for defining an aggregate web service, comprising:
selecting a plurality of web services;
extracting a definition language description from each of the plurality of web services;
encapsulating the definition language description with a plurality of tags to produce a plurality of encapsulated definition language descriptions;
aggregating the plurality of encapsulated definition language descriptions to produce an aggregation taxonomy defining the aggregate web service;
introspecting the aggregate web service;
deploying the aggregate web service to a web server container;
performing a sequence of transactions defined by the aggregate web service and returning a result to a web services client; and
registering the aggregate web service into a web service registry.

12] A web services aggregation system comprising:
a web service browser generating an aggregation taxonomy defining an aggregate web service;
an aggregator using the aggregation taxonomy to deploy the aggregated web service; and
a web service client sending a request to the aggregator to run the aggregated web service.

13] The system of claim 12, wherein the aggregate web service communicates via a simple object access protocol message.

14] The system of claim 12, further comprising:
a web services registry with an address of the aggregate web service to direct the request from the web services client to the aggregator.

15] The system of claim 14, wherein the web service registry is universal description discovery and integration-compliant.

16] The system of claim 12, further comprising:
an encapsulator located on the web services browser encapsulating a definition language description of each of a plurality of web services with a plurality of tags used in generating the aggregation taxonomy.

17] The system of claim 16, wherein the definition language description is web services description language description.

18] The system of claim 16, wherein the plurality of tags are defined by extensible markup language.

19] The system of claim 12, further comprising:
a menu feature of the web services browser comprising an introspect function, an invoke function, and a deploy function.

20] A web services aggregation system comprising:
a web service browser generating an aggregation taxonomy defining an aggregate web service;
an aggregator using the aggregation taxonomy to deploy the aggregated web service;
a web service client sending a request to the aggregator to run the aggregated web service;
a web services registry with an address of the aggregate web service to direct the request from the web services client to the aggregator;
an encapsulator located on the web services browser encapsulating a definition language description of each of a plurality of web services with a plurality of tags used in generating the aggregation taxonomy; and
a menu feature of the web services browser comprising an introspect function, an invoke function, and a deploy function.

21] A computer system for defining an aggregate web service, comprising:
a processor;
a memory;
an input means; and
software instructions stored in the memory for enabling the computer system under control of the processor, to perform:
selecting a plurality of web services;
extracting a definition language description from each of the plurality of web services;
encapsulating the definition language description with a plurality of tags to produce a plurality of encapsulated definition language descriptions; and
aggregating the plurality of encapsulated definition language descriptions to produce an aggregation taxonomy defining the aggregate web service.

22] The system of claim 21, wherein the definition language description is web services description language description.

23] The system of claim 21, wherein the plurality of tags are defined by extensible markup language.

24] The system of claim 21, wherein the aggregate web service communicates via a simple object access protocol message.

25] The system of claim 21, the aggregate web service comprising in turn a plurality of aggregate web services.

26] An apparatus to define an aggregate web service, comprising:
means for selecting a plurality of web services;
means for extracting a definition language description from each of the plurality of web services;
means for encapsulating the definition language description with a plurality of tags to produce a plurality of encapsulated definition language descriptions; and
means for aggregating the plurality of encapsulated definition language descriptions to produce an aggregation taxonomy defining the aggregate web service.
